(19) United States
(12) Patent Application Publication
(10) Pub. No.: US 2025/0102630 A1
(43) Pub. Date: Mar. 27, 2025

(54) Optical Modules with Aperture Edge Features

(71) Applicant: Apple Inc., Cupertino, CA (US)

(72) Inventors: Xi Chen, Santa Clara, CA (US); Arifin Arifin, Singapore (SG); Yi Chen, Santa Clara, CA (US); Xiaoyang Zhang, Singapore (SG); Qi Huang, Cupertino, CA (US)

(21) Appl. No.: 18/670,085

(22) Filed: May 21, 2024

Related U.S. Application Data
(60) Provisional application No. 63/540,828, filed on Sep. 27, 2023.

(51) Int. Cl. G01S 7/481

(52) U.S. Cl. CPC G01S 7/4813; G01S 7/4815

(57) ABSTRACT

An optical system includes a housing that defines a first aperture and a second aperture different from the first aperture. At least one of the first aperture or the second aperture is defined by a peripheral surface having a plurality of inclined surfaces with respect to a center axis of the first aperture or the second aperture. In some cases, the peripheral surface may define a convex profile, may have a coating or a surface treatment, or may define other edge features that help mitigate optical crosstalk. The optical system may also include an array of light emitters disposed within the housing and configured to emit light through the first aperture and a light detector disposed within the housing and configured to detect a portion of the emitted light that is returned from a target and received through the second aperture.

### CROSS-REFERENCE TO RELATED APPLICATION

This application is a nonprovisional and claims the benefit under 35 U.S.C. § 1.119(e) of U.S. Provisional Patent Application No. 63/540,828, filed Sep. 27, 2023, the contents of which are incorporated herein by reference as if fully disclosed herein.

### TECHNICAL FIELD

Embodiments described herein relate to optical modules and, in particular, to optical modules that may be used as proximity sensors in portable electronic devices.

### BACKGROUND

Portable electronic devices may include proximity sensors that are used to detect the proximity of an object or a user with respect to a reference point in the portable electronic device. In some examples, proximity sensors are used to determine a type of object and/or a type of matter that is proximate to the reference point in the portable electronic device. Due to the limited space in some devices, reducing the size of optical modules that are used as proximity sensors while increasing the field of view of the module is desirable. However, some optical components within these modules, which help increase the field of view of light emitters, increase optical crosstalk between a light emitter and a light detector due to the high angle rays generated by the optical components.

### SUMMARY

Embodiments described herein relate to apertures in optical modules and to edge features of those apertures which can reduce optical crosstalk between a light emitter and a light detected. As described herein, the light emitter may emit light through a first aperture and a light detector that may receive portions of the emitted light through a second aperture. In various embodiments, an optical module may include edge features in the first aperture, the second aperture, or both the first aperture and the second aperture.

A first example optical module may include a housing that defines a first cavity, a first aperture associated with the first cavity, a second cavity optically isolated from the first cavity, and a second aperture associated with the second cavity. At least one of the first aperture or the second aperture may have a plurality of widths (or diameters, for an aperture having a circular cross-section) measured transverse to a depth of the first aperture or the second aperture. A first width of the plurality of widths may be at an intermediate position between a respective end of one of the first cavity or the second cavity and an exterior surface of the housing. A second width of the plurality of widths may be at the exterior surface of the housing. A third width of the plurality of widths may be at the respective end of the first cavity or the second cavity. In some cases, the first width is smaller than the second width and the third width. The optical module may also include a light emitter disposed in the first cavity and configured to emit light through the first aperture and a light detector disposed in the second cavity and configured to receive a portion of the light emitted by the light emitter and returned from an object external to the optical module.

In some cases, the first aperture or the second aperture is defined by at least a first portion and a second portion that extend along the depth of the first aperture or the second aperture. The first portion may define a first countersink extending from the exterior of the housing to the intermediate position, and the second portion may define a second countersink extending from the first cavity or the second cavity to the intermediate position.

According to some embodiments, the first aperture or the second aperture is defined by at least a first portion and a second portion that extend along the depth of the first aperture or the second aperture. The first portion and the second portion may cooperate to define a convex profile along the depth of the first aperture or the second aperture.

As another example, the housing has a first peripheral surface having a first peripheral surface profile. The first peripheral surface may define a periphery of the first aperture along the depth of the first aperture. The housing may also have a second peripheral surface having a second peripheral surface profile. The second peripheral surface may define a periphery of the second aperture along the depth of the second aperture. In some variations, the second peripheral surface profile is different from the first peripheral surface profile.

In some cases, the second peripheral surface profile is a sawtooth profile. Additionally or alternatively, a coating may be disposed on the second peripheral surface. The coating is configured to absorb or block emitted light. As another example, the first width may be defined by a baffle defining a protruding portion of a peripheral surface along the depth of the first aperture or the second aperture.

A second example optical system described herein may have a housing that defines a first aperture and a second aperture different from the first aperture. In some cases, at least one of the first aperture or the second aperture is defined by a peripheral surface having a plurality of (two or more) inclined surfaces with respect to a center axis of the first aperture or the second aperture. The optical system also includes one or an array of light emitters disposed within the housing and configured to emit light through the first aperture and one or an array of light detectors disposed within the housing and configured to detect a portion of the emitted light that is returned from a target and received through the second aperture.

In some cases, the plurality of inclined surfaces define a sawtooth profile. In some examples, a first inclined surface of the plurality of inclined surfaces extends from an intermediate portion of the first aperture to an exterior surface of the housing, a second inclined surface of the plurality of inclined surfaces extends from an intermediate portion of the first aperture to an interior surface of the housing, and the intermediate portion may define a narrowest width of the first aperture.

In some variations, the housing also includes a wall coupled to a substrate. The wall may block the light emitted by the array of light emitters from impinging on the light detector before the emitted light passes through the first aperture and the second aperture.

In some examples, the housing defines a first cavity and a second cavity. The array of light emitters may be positioned within the first cavity, and the light detector may be positioned within the second cavity.

In accordance with some embodiments, the first aperture is defined by the peripheral surface, and the peripheral surface is a first peripheral surface. The second aperture is defined by a second peripheral surface, the second peripheral surface may include a first edge profile different from a second edge profile of the second peripheral surface.

In some cases, the optical system may include a lens mounted to the housing over at least one of the first aperture or the second aperture and an adhesive layer between the housing and the lens.

A third example optical module may have a housing. The housing defines a first region associated with a first aperture and a second region associated with a second aperture. The second aperture is positioned a distance from the first aperture. The housing further has a coating on a peripheral surface of at least one of the first aperture or the second aperture. The coating may be configured to absorb or scatter light. The optical module may also include a lens mounted over the first aperture, an adhesive layer positioned between the lens and the housing, a light emitter positioned within the first region, and a light detector positioned within the second region.

In some cases, the coating is positioned over only a portion of a perimeter of a peripheral surface of the first aperture. In some examples, the coating is a first coating disposed over a first peripheral surface of the first aperture. The optical module further includes a second coating disposed over a second peripheral surface of the second aperture. The first coating comprises a first material, and the second coating includes a second material that is different from the first material.

In some embodiments, the second aperture has a polygonal shape having a plurality of sides. At a first side of the plurality of sides, the second aperture is defined by a first edge profile along a depth of the second aperture. At a second side of the plurality of sides, the second aperture is defined by a second edge profile along the depth of the second aperture. The first edge profile may be different from the second edge profile.

The peripheral surface of the first aperture has a depth. In some cases, at least a portion of the peripheral surface defines an arcuate profile along the depth. As another example, the optical module has an adhesive layer coupled to an external portion of the housing, and the coating absorbs or scatters at least a portion of the emitted light that reflects from or within the adhesive layer.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts an example electronic device in which an optical module described herein may be incorporated.

FIG. 2 depicts a cross-sectional view of an example optical module described herein.

FIG. 3 depicts an exploded view of an example optical module described herein.

FIG. 4 depicts a plan view of an example optical module described herein.

FIG. 5A depicts a cross-sectional view of an example optical module described herein.

FIGS. 5B-5D depict detailed views of example aperture edge features of the optical module.

FIG. 6A depicts a cross-sectional view of an example optical module described herein.

FIGS. 6B-6C depict detailed views of example aperture edge features of the optical module.

FIG. 7 depicts a cross-sectional view of an example optical module described herein.

FIG. 8 depicts an example block diagram of an electronic device in which an optical module described herein may be incorporated.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to optical modules that reduce optical crosstalk. The optical modules described may be mounted within electronic devices such as phones, tablets, headphones, AR/VR headsets, laptops, and so on and may be used for proximity detection, type of matter detection, and/or other purposes.

As described herein, an optical module may be configured to reduce optical crosstalk between a light emitter and a light detector by modifying edge features of an aperture through which the light emitter emits light and/or an aperture through which the light detector receives light. The optical module may include one or more light emitters (e.g., an array of light emitters) that emit light towards a target and one or more light detectors that detect a portion of the emitted light that is reflected from the target. The optical module may also include a housing that surrounds the light emitters and light detectors. In some cases, the housing defines an aperture through which light is transmitted (e.g., by the light detectors) and an aperture through which reflected light passes and is detected by the optical detector. Each of these apertures may have edge features that define narrowing widths (or expanding widths) at an intermediate position along a depth of the aperture (e.g., a narrowing portion taken along a cross section of the aperture). In some cases, the housing portion along the depth of the aperture (e.g., taken along a cross section) defines at least one of: an arcuate profile, a countersink, a taper, a chamfer, and so on. Each of these edge features along the aperture may help reflect and/or absorb light such that optical crosstalk caused by light reflecting off or within optical elements of the optical module is mitigated.

In an example optical module, the light emitters and the light detectors are positioned within cavities of the housing. In this configuration, an end of each cavity includes a respective aperture. Specifically, a first cavity may be positioned within the region of the optical module emitting light and may have a first aperture associated with that cavity (e.g., to optically connect the cavity to an environment outside of the optical module). Similarly, a second cavity may be positioned within the region of the optical module receiving light and may have a second aperture associated with that cavity (e.g., to optically connect the cavity to the environment outside of the optical module). Each of the apertures may include optical elements, such as a lens (e.g., a cylindrical lens array or other light-diffusing optical elements) configured to increase the field of illumination of the optical module. The optical module may be additionally mounted within a portable electronic device behind a cover (e.g., an optically-clear cover such as glass) via an optically-clear adhesive (OCA). Each of the lens, the OCA, and the cover may have the same or different indices of refraction, which affect how the light is transmitted from the optical emitters to the optical detector. Due to the differences in refraction index and geometry of the lens, light may be reflected within each of these components and may generate optical crosstalk (e.g., high angle rays may generate optical crosstalk). Edge features (e.g., the geometry of the aperture along its depth) may help reduce this optical crosstalk.

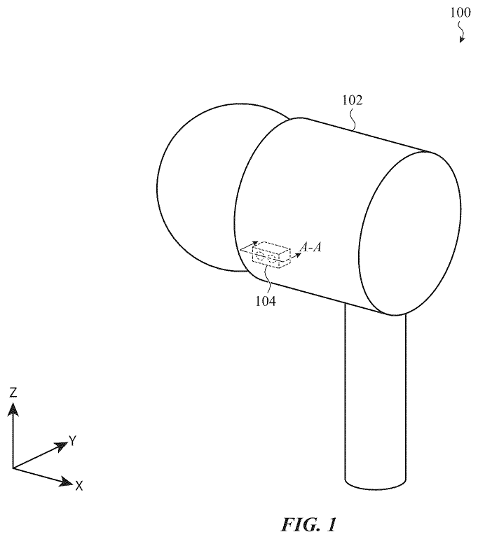

The foregoing and other embodiments are discussed below with reference to FIGS. 1-8. However, those skilled in the art will readily appreciate that the detailed description given herein with respect to these figures is for explanation only and should not be construed as limiting.

As discussed above, the optical module described herein may be incorporated into portable electronic devices, including headphones, earbuds, phones, tablets, AR/VR headsets, laptops, watches, and so on. FIG. 1 shows an example portable electronic device (an earbud 100) into which one of the optical modules described herein may be incorporated. The earbud 100 may be a wireless headphone which may be coupled wirelessly, e.g., via BLUETOOTH® or other wireless protocol, to a network that allows a user to listen to music, get directions, talk on the phone, and so on. The earbud 100 shown may be inserted into a user's ear and may include speakers, microphones, sensors, and other electronic components and/or circuitry. The earbud 100 may include a housing or a housing assembly 102 in which the speaker, microphones, sensors, and other electrical circuitry are positioned. In some cases, the earbud 100 may include a stem or other structural feature(s) which are part of the housing 102, and which may provide additional user controls, including buttons and other input devices or mechanisms.

The electronic components and/or circuitry can be configured to acquire an audio signal from the microphone, transmit audio signals from a processor, and/or communicate with other electronic devices and send signals to other devices (e.g., to a phone communicatively coupled to the earbud 100). The electronic components and/or circuitry may communicate via wireless communications interfaces, such as Wi-Fi, BLUETOOTH®, cellular radio communication, and the like, or via a wired communications interface such as Universal Serial Bus (USB) or the like.

An optical module 104 may be positioned within the earbud 100 proximate to a wall of the housing 102. While the optical module 104 is shown as positioned within the main body of the earbud 100, the optical module 104 may alternatively be positioned within the stem of the earbud 100 or at any suitable location. As discussed above, the optical module 104 may be used to determine a proximity of the user to the earbud 100, to receive input from a user, to distinguish types of matter (e.g., whether the earbud 100 is positioned in a user's ear or lying on an object), and so on. Processors and other electrical components may receive signals from one or more components of the optical module 104. These signals may be used to adjust settings of the earbud 100, provide outputs to the user, and/or convey other information to additional devices and/or to a network.

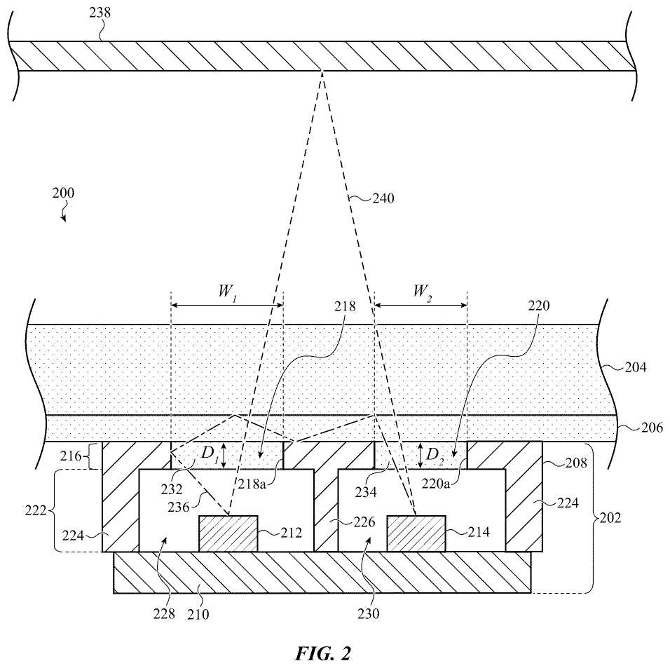

FIG. 2 shows a cross-sectional view along line A-A of an optical system 200 mounted within an electronic device, such as the electronic device 100 of FIG. 1. As depicted, the optical system 200 includes an optical module 202 that is mounted behind a cover 204 of the electronic device 100. The optical module 202 and the cover 204 may be coupled via an adhesive layer 206. While optical system 200 is shown to be incorporated in electronic device 100, the optical module may be incorporated using a similar configuration within other electronic devices, such as phones, watches, tablets, AR/VR headsets, laptops, and so on.

In some embodiments, the optical module 202 includes a housing 208 that is coupled to a substrate 210 on which light emitter 212 and light detector 214 are positioned. As depicted, the housing 208 has a first portion 216 that defines a first aperture 218 and a second aperture 220. The first aperture 218 may be a through-aperture having a depth D₁. The second aperture 220 may be a through-aperture having a depth D₂. In some examples, depths D₁ and D₂ correspond to the thickness (e.g., wall thickness) of the first portion 216 of the housing.

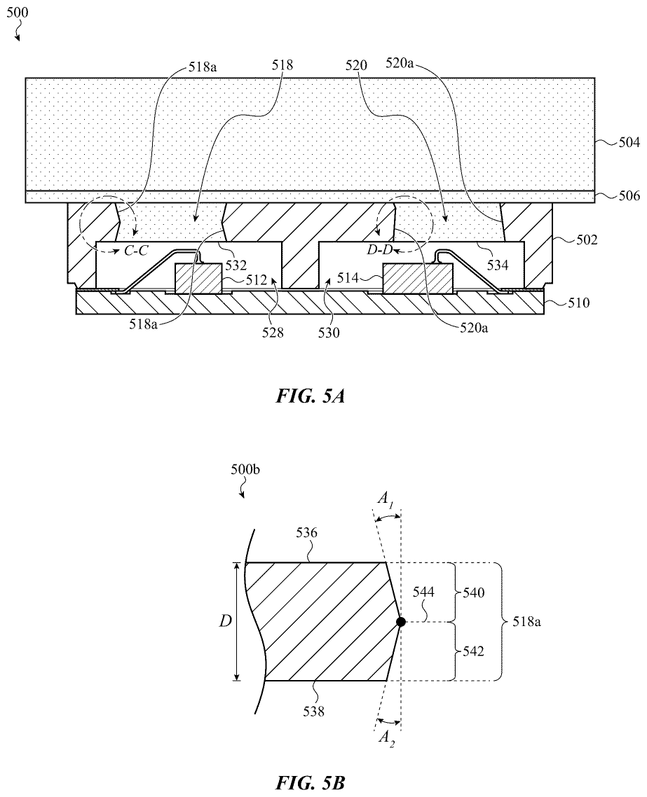

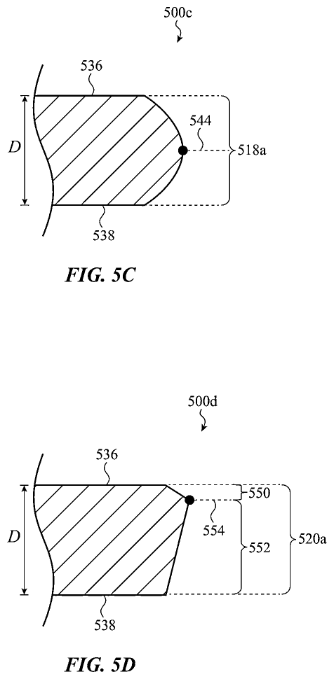

The boundaries of the first aperture 218 along its depth D₁ may be defined by a peripheral surface 218a. The peripheral surface 218a may, in turn, define an edge profile of the first aperture 218. The edge profile along the peripheral surface 218a may take a number of shapes, as described below, to reduce optical crosstalk. More specifically, the first aperture 218 may include a width W₁ measured transverse to the depth D₁ of the first aperture 218. As shown in the examples of FIGS. 5A-7, the width W₁ of the aperture may be replaced with a varying width along the depth of the aperture.

Similarly, the boundaries of the second aperture 220 along its depth D₂ may be defined by a peripheral surface 220a. The peripheral surface 220a may, in turn, define an edge profile of the second aperture 220. The edge profile along the peripheral surface 220a may take a number of shapes, as described below, to reduce optical crosstalk. More specifically, the second aperture 220 may include a width W₂ measured transverse to the depth D₂ of the second aperture 220. The width W₂ may be replaced with a varying width along the depth of the aperture in the examples described in FIGS. 5A-7.

The housing also defines a second portion 222 that includes a series of peripheral wall(s) 224 and internal wall(s) 226. The peripheral wall(s) 224 and the internal wall(s) 226 may collectively define a first cavity 228 and a second cavity 230. The first cavity 228 may, at least partially, surround the light emitter 212. The second cavity may, at least partially, surround the light detector 214. The first cavity 228 may be defined by a first end and a second end. The first end may be at the substrate 210 (e.g., at an interior surface of the substrate). The second end of the first cavity may be at an interior surface of the first portion 216 and one end of the first aperture 218. More generally, the first aperture 218 and the second aperture 220 may be defined along the first portion 216. For example, the first aperture 218 and the second aperture 220 may extend from the interior surface of the first portion 216 to the exterior surface of the first portion 216. In some embodiments, the exterior and interior surfaces of the first portion 216 corresponds to the interior and exterior surface of the housing, the exterior surface being opposite the interior surface. As described herein, the first cavity 228 is different from the first aperture 218. Similarly, the second cavity 230 may be defined by a first end at the substrate 210 and a second end at the interior surface of the first portion 216 and one end of the second aperture 220.

In this configuration, the first cavity 228 and the first aperture 218 are optically coupled. In other words, the light emitter 212 emits light from the first cavity 228 and through the aperture 218. Similarly, the second cavity 230 is optically coupled to the second aperture 220. Thus, light travels through the second aperture 220 and into the second cavity 230 and may be received by the light detector 214. In some embodiments, the internal wall 226 optically isolates the first cavity 228 from the second cavity 230.

More generally, the housing 208 may be a single, monolithic piece which defines the first and second portions 216 and 222. The housing 208 may couple directly to the substrate 210. In some embodiments, the substrate may be part of the housing 208. While a housing with two apertures is described, the optical module 202 may include an array of light emitters positioned in one or more cavities of the housing 208, and/or one or more light detectors 214 positioned in one or more cavities of the housing 208.

In some embodiments, the optical module 202 includes optical elements 232 and 234. The optical elements 232 and 234 may be a lens array (e.g., a cylindrical lens array) that diffuses light on a first axis parallel to the substrate 210 and passes light on a second axis orthogonal to the first axis. Optical elements 232 and 234 may be an assembly of one or more lenses or other optical elements.

The optical module 202 may be coupled within the electronic device via the adhesive layer 206. In some embodiments, the adhesive layer 206 may be an optically clear adhesive (OCA). The adhesive layer 206 may be positioned between the optical module 202 (abutting the first portion 216 of the housing and the optical elements 232 and 234) and the cover 204. The cover 204 may also be optically clear. Each of the optical elements 232 and 234, the adhesive layer 206, and the cover 204 may have corresponding indices of reflectivity. In some cases, the indices of reflectivity may be similar or the same, depending on the material of each the optical elements, the adhesive layer, and the cover. While different materials are disclosed, in some embodiments some or all materials may be an air gap.

FIG. 2 depicts two example simplified light paths for illustration. Example light path 236 shows an example of optical crosstalk within the optical system 200. As depicted, in light path 236, the light emitter 212 emits light that reflects from peripheral surface 218a, within the adhesive layer 206, and towards the light detectors 214. As depicted in this light path 236, the light does not reach the target area 238. In this light path 236, the geometry and different layers with different reflectivity indices are conducive to optical crosstalk. By contrast, light path 240 shows a desirable path because the light emitted by the light emitter 212 reaches the target area 238 and returns to the light detector 214. While configuring the optical device to have direct light paths to the target may be desirable to reduce optical crosstalk, the field of view of the device may be more limited. Similarly, by eliminating materials that may introduce optical crosstalk, components like the adhesive layers generally simplify manufacturing and provide a wider range of mounting options for optical modules. The device described herein mitigates optical crosstalk with the existing architecture (e.g., with optical elements and OCA) as described herein.

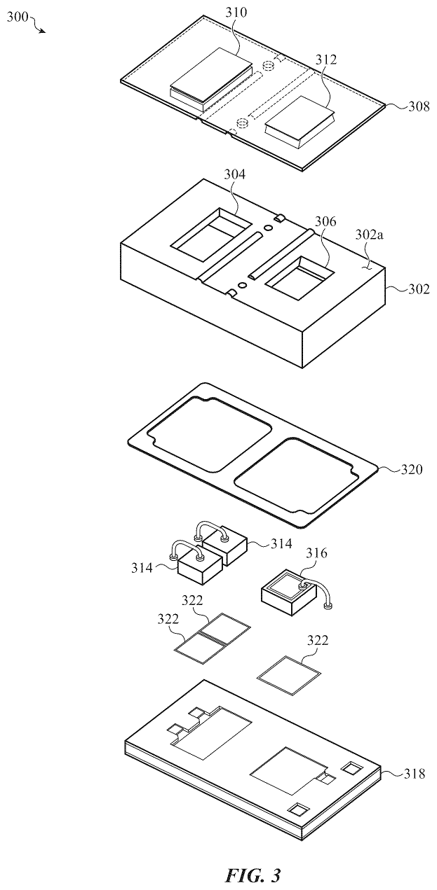

The embodiments depicted in FIG. 3-7, and the various alternatives thereof and variations thereto, are presented, generally, for purposes of explanation and to facilitate an understanding of various configurations and constructions of a system, such as described herein. However, it will be apparent to one skilled in the art that some of the specific details presented herein may not be required in order to practice a particular described embodiment or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

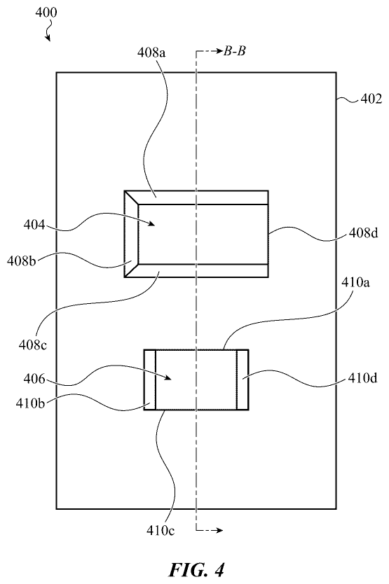

FIG. 3 shows an exploded view of an example optical module 300 for optical crosstalk mitigation. In some variations, the optical module 300 includes a housing 302 which partially encloses the optical elements and light emitting elements. The housing 302 includes apertures 304 and 306, which are configured to pass emitted and received light, respectively. As explained in FIGS. 4-7 below, the apertures 304 or 306 may include edge features (e.g., different profiles along the peripheral surface of the aperture) which mitigate optical crosstalk.

The optical module 300 may include optical elements that improve the field of view of the optical module. In some cases, the optical module 300 includes a top film 308. The top film carries a first optical element 310 and a second optical element 312. The first optical element 310, as discussed above, may be positioned partially within the aperture 304 and over a light emitter array 314. In this configuration, the first optical element 310 may receive light emitted by the light emitters that passes through the first aperture 304, and the first optical element 310 may pass this light to an environment exterior to the optical module. In some cases, the first optical element 312 may introduce unwanted high angle rays that may increase optical crosstalk in traditional optical modules.

The second optical element 312 may be positioned partially within the aperture 306. Generally, the second optical element 312 has a different optical configuration that receives light (e.g., from a target) and passes the light to an optical detector 316. The second optical element 312 is configured to transmit light received from a wider field of view compared to apertures that are not associated with such an optical element. The first optical element 310 and the second optical element 312 may define optical windows, which are mounted partially within the apertures 304 and 306, respectively.

In some cases, the first and second optical elements, 310 and 312, may be formed of one or more of glass, plastic (such as a plastic resin), and the like. In examples where plastic is used, the plastic may be temperature tolerant for manufacturing and assembly processes. The first and second optical elements, 310 and 312, may be centered by the apertures 304 and 306. The top film 308 may be positioned within the housing 302 (e.g., between different portions of the housing 302) or it may be positioned over an exterior surface 302a of the housing 302.

The optical module 300 includes a substrate 318 which may be coupled to the housing 302 via an adhesive 320. In some examples, the housing 302 and the substrate 318 are formed integrally. The light emitter array 314 and the optical detector 316 may each be coupled to the substrate 318 via coupling elements 322. In some examples, the coupling elements may include adhesives (e.g., glue), connectors, and the like. The substrate 318 provides power and transmits signals to and from the light emitter array 314 and to (and possibly from) the light detector 316 (e.g., via a flexible circuit).

FIG. 4 shows a plan view of an optical module 400. The optical module 400 may be incorporated into electronic device 100 and may include the parts described for the optical module 300 in FIG. 3. As described above, the housing 402 of the optical module 400 includes a first aperture 404 and a second aperture 406. As shown in the figure, the first aperture 404 may have different dimensions or a different shape compared to the second aperture 406 (though it need not). While the apertures, 404 and 406, are shown aligned with respect to a centerline of the housing 402, other alignments and other spacings between the apertures and periphery of the housing are envisioned.

The housing 402 may include one or more edge features 408a-d which define the peripheral surface of the aperture 404. As described above, the term “edge feature” refers to a profile of the peripheral surface of an aperture along the depth of the aperture. Edge feature 408a may be tapered, angled, arcuate, or have any other feature (described in more detail in the cross-sections of FIGS. 5A-7) which narrows at an intermediate or other portion along the depth of the aperture 404.

In some examples, edge features 408b and 408c may have similar or the same features as 408a, or their profiles may vary. Edge feature 408d may have a different profile along the peripheral surface of the aperture 404. For example, edge feature 408d may have a straight profile, as depicted in the figure. In some cases, the edge features 408a-d may be symmetrical. In other examples, the edge features may be positioned on only one side of the aperture. For circular, oval, elliptical, or similar apertures, an edge feature may span only a portion of the perimeter of the aperture. Similarly, for triangular, polygonal, or similar apertures, an edge feature may be positioned along only one side (or fewer than all sides) of an aperture or along only a portion of a side of the aperture. The edge features 408a-d and their relative locations to the housing 402 may help mitigate optical crosstalk due to optical elements, adhesive layers, covers, air, and other structures or materials.

The housing 402 may also include one more edge features 410a-d that define the peripheral surface of the aperture 406. Edge features 410a-d may be different from edge features 408a-d to direct light towards the cavity where the optical detector is housed. The edge features 410a-d may be located in different directions relative to the edge features 408a-d. As depicted in the figure, edge features 410a and 410c may be straight edges while edge features 410b and 410d may have an arcuate or angled profile. As described herein, a profile along the peripheral surface refers to the shape of the surface as viewed from a cross-section of the aperture.

FIG. 5A shows a cross-sectional view of an optical module 400 along line B-B of FIG. 4. As depicted in FIG. 5A, an optical module 502 may include the substrate 510, the light emitter array 512 positioned within cavity 528, the light detector 514 positioned within cavity 530, the adhesive 506, the cover 504, and optical elements 532 and 534. The configuration of these components may be similar to or the same as the components described with reference to FIG. 2. As depicted in FIG. 5A, one or more of the apertures (e.g., 518, 520) may be defined by a respective peripheral surface along the depth of the aperture (e.g., the aperture may have a respective edge feature). The peripheral surface 518a or 520a mitigates optical crosstalk due to high angle rays reflected within air, adhesives, optical elements, or other layers of the optical system. More specifically, an edge feature may define a draft angle of the peripheral surface with respect to a vertical axis, which the draft angle helps redirect light to mitigate optical crosstalk compared to surfaces with no draft angle. For example, light reflecting from a peripheral surface 518a may be redirected away from the optical module 502. By contrast, light reflecting from a peripheral surface 218a (in FIG. 2) may be redirected towards an opposite surface of the aperture and/or towards the adhesive 206 in a way that the light does not reach the target and is reflected back to the detector.

In some embodiments, the apertures, 518 and 520, may have symmetrical peripheral surfaces. However, as discussed in FIG. 4 above, the peripheral surfaces may alternatively define different profiles along the peripheries of respective different apertures. As shown in FIG. 5A, the peripheral surface 518a may be different from the peripheral surface 520a.

FIG. 5B shows a detailed view along section C-C of FIG. 5A. FIG. 5B shows the peripheral surface 518a along a depth D of the aperture 518. The detailed view shows a variation of the optical module 500b. As depicted in the figure, the peripheral surface 518a may extend from an exterior surface 536 of the optical module 500b to an interior surface 538 of the optical module 502. The exterior surface 536 of the optical module 500b may be opposite the interior surface 538 of the optical module. The peripheral surface 518a includes a first portion 540 and a second portion 542. In some examples, the first portion 540 extends from an exterior surface 536 to an intermediate position 544, and the second portion 542 extends from an interior surface 538 to the intermediate position 544.

In some embodiments, the first portion 540 defines an angled or inclined surface having an angle A₁ with respect to a vertical axis. In some cases, the inclined surface of the first portion 540 faces towards the exterior surface 536 of the optical module 500b. In other words, an axis normal to the inclined surface points away from the optical module 500b. The second portion 542 defines another angled or inclined surface having an angle A₂ with respect to the vertical axis. In some examples, the first and second portions 540 and 542 intersect at the intermediate position 544 and have a point of inflection between both portions. In some cases, the inclined surface of the second portion 542 faces towards the interior surface 538 of the optical module 500b. In this configuration, an axis normal to the inclined surface of the second portion 542 points towards the inside of the optical module 500. Due to this configuration, the width of the aperture along the depth D changes (e.g., the aperture has a plurality of different widths along its depth). More specifically, the width of the aperture at and/or around the intermediate position 544 is less than the width of the aperture adjacent to the ends of the aperture—e.g., adjacent to exterior surface 536 and adjacent to interior surface 538. In embodiments where the aperture 518 is symmetrical along a cross-section, the varying with defines a waist-like profile along the depth of the aperture 518. In some examples, the narrowest width may be at the intermediate position. In some embodiments, the first portion defines a first countersink and the second portion defines a second countersink. The first and the second countersink may be mirror images of each other, with the narrow portion of the first countersink at the intermediate position and the widest portion of the countersink at the exterior surface.

In some cases, the intermediate position 544 is in the middle portion of the peripheral surface 518a. In other cases, the intermediate position 544 may be closer to the exterior surface 536 or closer to the exterior surface 538.

FIG. 5C shows an alternative to the peripheral surface 518a shown in FIG. 5B. As depicted in this variation, the peripheral surface 518a along a depth D of the aperture 518. As depicted in this variation for optical module 500c, the peripheral surface 518a may have a convex profile. In particular, the peripheral surface 518a may curve outward (e.g., in a direction towards the center of the aperture 518). As the peripheral surface 518a curves outward, the width of the aperture 518 narrows and may define a narrowest width at intermediate position 554. In this configuration, the aperture may define a waist-type profile. In some configurations, the peripheral surface 518a may define other curved or arcuate profiles. In these variations, the peripheral surface 518a may curve outward (e.g., in a direction towards the center of the aperture 518). When light reflects from a point along the peripheral surface, the curvature along the peripheral surface 518a may help reflect light in a direction that mitigates optical crosstalk.

FIG. 5D shows a detailed view along section D-D of FIG. 5A. FIG. 5D shows the peripheral surface 520a along a depth D of the aperture 520. FIG. 5D also illustrates that the peripheral surface from the aperture 520, which is over the light detector, may have a different configuration from the aperture 518, which is over the light emitter array. As shown in FIG. 5D, the peripheral surface 520a may include a first portion 550 and a second portion 552. In some embodiments, the second portion 552 may represent a significant portion (e.g., more than 70%) of the peripheral surface 520a. The second portion 552 may define an inclined surface which faces the interior surface 538 of the optical module 500d. In this embodiment, light may reflect from the second portion and towards the light detector. The first portion 550 may have a surface that faces towards an exterior surface 536 of the optical module 500d.

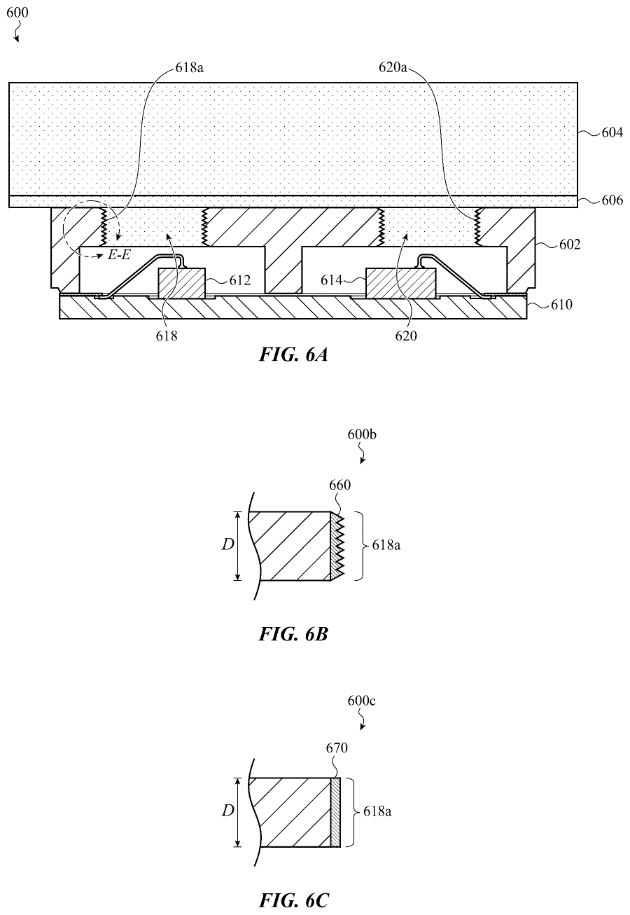

FIG. 6A shows a variation of the cross-sectional view from FIG. 5A. The optical module 602 may include the substrate 610, the light emitter array 612, the light detector 614, the adhesive 606, and the cover 604. The configuration of these components may be similar to or the same as the components described with reference to FIG. 2 and/or FIG. 5A. As depicted in FIG. 6A, one or more of the apertures (e.g., 618, 620) may be defined by a peripheral surface along the depth of the aperture (e.g., the aperture may have a respective edge feature). The peripheral surface 618a or 620a mitigates optical crosstalk due to air, adhesives, optical elements, other materials, or the like.

While FIGS. 5A-5D show different edge features along the peripheral surfaces, 518a and 520a, FIG. 6A shows respective peripheral surfaces, 618a and 620a, corresponding to apertures 618 and 620 having surface treatments and/or coatings to mitigate optical crosstalk. In some embodiments, the surface treatments and/or coatings described herein may be applied instead of or in addition to the edge features shown in FIGS. 5A-5D.

FIG. 6B shows a detailed view along section E-E of FIG. 6A and FIG. 6C shows an alternative view to what is shown in FIG. 6B. Each FIGS. 6B and 6C show example surface treatments and/or coatings configured to mitigate optical crosstalk. As shown in FIG. 6B, the variation of optical module 600b includes a peripheral surface 618a having a surface treatment 660. In some embodiments, the surface treatment 660 creates a sawtooth profile along the peripheral surface 618a, or the surface treatment 660 may be applied to a sawtooth (or other) profile. The surface treatment 660 may be formed using any suitable method, as may be known to one of skill in the art. The sawtooth profile may help to reflect light at different angles and/or absorb light to mitigate optical crosstalk. In some embodiments, the surface treatment may be applied along a portion of the peripheral surface 518a (e.g., a portion along the depth of the peripheral surface, or a portion along the perimeter of the peripheral surface, as described with reference to FIG. 4). While the above explanation refers to peripheral surface 618a, a similar or same surface treatment may be applied to peripheral surface 620a.

As shown in the variation of the optical module 600c in FIG. 6C, the peripheral surface 618a may include a coating 670. The coating 670 may be configured to absorb or scatter incident light. In some cases, such as those for aperture 618 within a light-emitting region of the optical module, it may be desirable to scatter light to increase the field of view of the module with respect to the target. In some cases, for example, as applied to the light-detecting region at aperture 620, it may be desirable to absorb light with high angle rays because of the likelihood that these high angle rays represent optical crosstalk from the adhesive, cover, or other layers of the device. Some example coatings include an optically black coating, anti-reflection coatings, mirror coatings, and the like. The coating 670 may be applied to a portion of the peripheral surface 618a along its depth, a portion of the peripheral surface 618a along its perimeter, the entire depth and perimeter of the peripheral surface 618a, and so on. The coating 670 may also be applied to peripheral surface 620a in the same or similar manner described as to peripheral surface 618a. As explained above, each aperture 618, 620 may have different coatings.

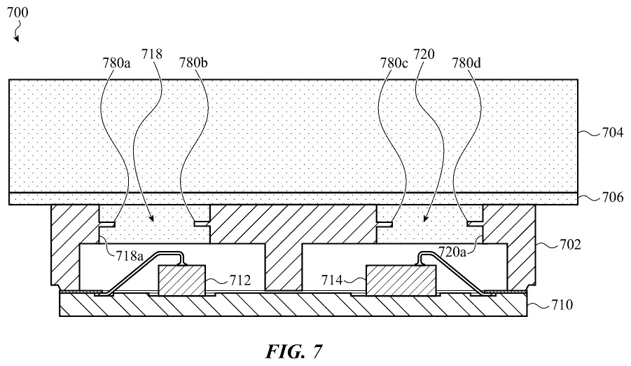

FIG. 7 shows a variation of the cross-sectional view from FIG. 5A. The optical module 702 may include the substrate 710, the light emitter array 712, the light detector 714, the adhesive 706, and the cover 704. The configuration of these components may be similar to or the same as the components described with reference to FIG. 2, FIG. 5A, and/or FIG. 6A. As depicted in FIG. 7, one or more of the apertures (e.g., 718, 720) is defined by a peripheral surface along the depth of the aperture (e.g., an edge feature). The peripheral surface 718a, 720a mitigates optical crosstalk due to air, adhesives, optical elements, other materials, or the like.

FIG. 7 may incorporate features along the aperture which help mitigate optical crosstalk. As an example, the apertures 718 or 720 may include baffles 780a-d. The baffles 780a-d may be positioned at an intermediate portion of the peripheral surface 718a or 720a. For example, baffle 780a protrudes from the peripheral surface 718a. In some cases, baffle 780a defines a continuous portion along a perimeter of the aperture 718. In some embodiments, the baffles may be segments protruding from the peripheral surface 718a. More generally, the baffles may be configured to redirect and/or reflect incident light. In particular, the baffles may redirect high angle rays (e.g., rays that generally cause optical crosstalk) towards the target and/or away from the light detectors. While a single baffle is shown, in other embodiments the apertures may include multiple baffles at different depths of the apertures. In some cases, the baffles may span a portion of the perimeter (e.g., one side or two sides of the aperture). As yet another example, the baffle may include surface treatments and/or coatings, such as those described with reference to FIGS. 6A-6C.

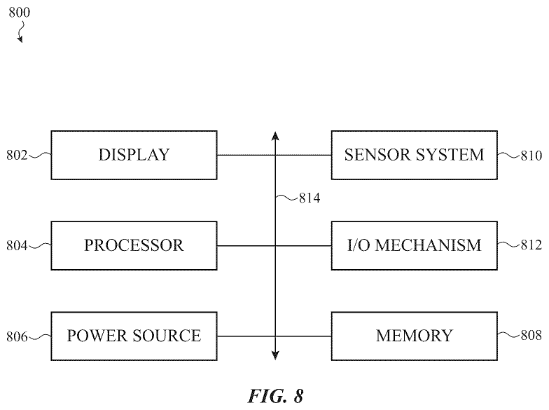

FIG. 8 shows an example electrical block diagram of an electronic device 800, which electronic device may in some cases incorporate aspects of the optical systems or electronic devices described with reference to FIGS. 1 and 3-7. The electronic device 800 may include an optional display 802 (e.g., a light-emitting display), a processor 804, a power source 806, a memory 808 or storage device, a sensor system 810, or an input/output (I/O) mechanism 812 (e.g., an input/output device, input/output port, or haptic input/output interface). The processor 804 may control some or all of the operations of the electronic device 800. The processor 804 may communicate, either directly or indirectly, with some or all of the other components of the electronic device 800. For example, a system bus or other communication mechanism 814 can provide communication between the display 802, the processor 804, the power source 806, the memory 808, the sensor system 810, and the I/O mechanism 812.

The processor 804 may be implemented as any electronic device capable of processing, receiving, or transmitting data or instructions, whether such data or instructions is in the form of software or firmware or otherwise encoded. For example, the processor 804 may include a microprocessor, a central processing unit (CPU), an application-specific integrated circuit (ASIC), a digital signal processor (DSP), a controller, or a combination of such devices. As described herein, the term “processor” is meant to encompass a single processor or processing unit, multiple processors, multiple processing units, or other suitably configured computing element or elements. In some cases, the processor 804 may determine a proximity of the electronic device to a user or other object, as described with reference to FIGS. 1 and 3-7.

The power source 806 may be implemented with any device capable of providing energy to the electronic device 800. For example, the power source 806 may include one or more batteries or rechargeable batteries. Additionally or alternatively, the power source 806 may include a power connector or power cord that connects the electronic device 800 to another power source, such as a wall outlet. The power source 806 may also or alternatively include a wireless charging circuit.

The memory 808 may store electronic data that can be used by the electronic device 800. For example, the memory 808 may store electrical data or content such as, for example, audio and video files, documents and applications, device settings and user preferences, timing signals, control signals, and data structures or databases. The memory 808 may include any type of memory. By way of example only, the memory 808 may include random access memory, read-only memory, Flash memory, removable memory, other types of storage elements, or combinations of such memory types.

The electronic device 800 may also include a sensor system 810 positioned almost anywhere on the electronic device 800. In some cases, the sensor system 810 may include a light emitter and a light detector, positioned and/or configured as described with reference to any of FIGS. 1 and 3-7. The sensor system 810 may be configured to sense one or more types of parameters, such as, but not limited to: vibration; light; touch; force; heat; movement; relative motion; biometric data (e.g., biological parameters) of a user; air quality; proximity; position; connectedness; matter type; and so on. By way of example, the sensor system 810 may include one or more of (or multiple of) a position sensor, a proximity sensor, a light or optical sensor (e.g., an electromagnetic radiation emitter and/or detector), an accelerometer, a pressure transducer, a gyroscope, a magnetometer, a health monitoring sensor, an air quality sensor, and so on. Additionally, the sensor system 810 may utilize any suitable sensing technology, including, but not limited to, interferometric, magnetic, pressure, capacitive, ultrasonic, resistive, optical, acoustic, piezoelectric, or thermal technologies.

The I/O mechanism 812 may transmit or receive data from a user or another electronic device. The I/O mechanism 812 may include a touch sensing input surface, a crown, one or more buttons, one or more cameras (including an under-display camera), one or more microphones or speakers, one or more ports such as a microphone port, and/or a keyboard. Additionally or alternatively, the I/O mechanism 812 may transmit electronic signals via a communications interface, such as a wireless, wired, and/or optical communications interface. Examples of wireless and wired communications interfaces include, but are not limited to, cellular and Wi-Fi communications interfaces.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments, whether or not such embodiments are described and whether or not such features are presented as being a part of a described embodiment. Thus, the breadth and scope of the present description should not be limited by any of the above-described exemplary embodiments but is instead defined by the claims herein presented.

What is claimed is:

1. An optical module, comprising:
a housing defining,
a first cavity;
a first aperture associated with the first cavity;
a second cavity optically isolated from the first cavity;
a second aperture associated with the second cavity, at least one of the first aperture or the second aperture having a plurality of widths measured transverse to a depth of the respective first aperture or the second aperture:
a first width of the plurality of widths is at an intermediate position between an interior surface of the housing and an exterior surface of the housing, the exterior surface of the housing opposite the interior surface of the housing;
a second width of the plurality of widths is at the exterior surface of the housing; and
a third width of the plurality of widths is at the interior surface of the housing, the first width is smaller than the second width and the third width;
a light emitter disposed in the first cavity and configured to emit light through the first aperture; and
a light detector disposed in the second cavity and configured to receive a portion of the light emitted by the light emitter and returned from an object external to the optical module.

2. The optical module of claim 1, wherein:
the first aperture or the second aperture is defined by at least a first portion and a second portion that extend along the depth of the first aperture or the second aperture;
the first portion defines a first countersink extending from the exterior of the housing to the intermediate position; and
the second portion defines a second countersink extending from the first cavity or the second cavity to the intermediate position.

3. The optical module of claim 1, wherein:
the first aperture or the second aperture is defined by at least a first portion and a second portion that extend along the depth of the first aperture or the second aperture; and
the first portion and the second portion, in combination, define a convex profile along the depth of the first aperture or the second aperture.

4. The optical module of claim 1, wherein:
the housing has a first peripheral surface having a first peripheral surface profile, the first peripheral surface defining a periphery of the first aperture along the depth of the first aperture;
the housing has a second peripheral surface having a second peripheral surface profile, the second peripheral surface defining a periphery of the second aperture along the depth of the second aperture; and
the second peripheral surface profile is different from the first peripheral surface profile.

5. The optical module of claim 4, wherein:
the second peripheral surface profile is a sawtooth profile.

6. The optical module of claim 4, wherein:
a coating is disposed on the second peripheral surface, the coating is configured to absorb or block emitted light.

7. The optical module of claim 1, wherein:
the first width is defined by a baffle defining a protruding portion of a peripheral surface along the depth of the first aperture or the second aperture.

8. An optical system comprising:
a housing defining:
a first aperture; and
a second aperture different from the first aperture, at least one of the first aperture or the second aperture defined by a peripheral surface having a plurality of inclined surfaces with respect to a center axis of the first aperture or the second aperture;
an array of light emitters disposed within the housing and configured to emit light through the first aperture; and
a light detector disposed within the housing and configured to detect a portion of the emitted light that is returned from a target and received through the second aperture.

9. The optical system of claim 8, wherein:
the plurality of inclined surfaces define a sawtooth profile.

10. The optical system of claim 8, wherein:
a first inclined surface of the plurality of inclined surfaces extends from an intermediate portion of the first aperture to an exterior surface of the housing;
a second inclined surface of the plurality of inclined surfaces extends from the intermediate portion of the first aperture to an interior surface of the housing; and
the intermediate portion defines a narrowest width of the first aperture.

11. The optical system of claim 8, wherein the housing further comprises:
a wall coupled to a substrate, the wall blocking the light emitted by the array of light emitters from impinging on the light detector before the emitted light passes through the first aperture and the second aperture.

12. The optical system of claim 11, wherein:
the housing defines:
a first cavity; and
a second cavity;
the array of light emitters is positioned within the first cavity; and
the light detector is positioned within the second cavity.

13. The optical system of claim 8, wherein:
the first aperture is defined by the peripheral surface;
the peripheral surface is a first peripheral surface; and
the second aperture is defined by a second peripheral surface, the second peripheral surface having a first edge profile different from a second edge profile of the second peripheral surface.

14. The optical system of claim 8, further comprising:
a lens mounted to the housing over at least one of the first aperture or the second aperture; and
an adhesive layer between the housing and the lens.

15. An optical module comprising:
a housing defining:
a first region associated with a first aperture;
a second region associated with a second aperture, the second aperture positioned a distance from the first aperture; and
a coating on a peripheral surface of at least one of the first aperture or the second aperture, the coating configured to absorb or scatter light;
a lens mounted over the first aperture;
a light emitter positioned within the first region; and
a light detector positioned within the second region.

16. The optical module of claim 15, wherein:
the coating is positioned over only a portion of a perimeter of the peripheral surface of the first aperture.

17. The optical module of claim 15, wherein:
the coating is a first coating disposed over a first peripheral surface of the first aperture;
the optical module further comprises a second coating disposed over a second peripheral surface of the second aperture; and
the first coating comprises a first material and the second coating comprises a second material different from the first material.

18. The optical module of claim 15, wherein:
the second aperture has a polygonal shape having a plurality of sides;
at a first side of the plurality of sides, the second aperture is defined by a first edge profile along a depth of the second aperture;
at a second side of the plurality of sides, the second aperture is defined by a second edge profile along the depth of the second aperture; and
the first edge profile is different from the second edge profile.

19. The optical module of claim 15, wherein:
the peripheral surface has a depth; and
at least a portion of the peripheral surface defines an arcuate profile along the depth.

20. The optical module of claim 15, further comprising:
an adhesive layer coupled to an external portion of the housing; wherein,
the coating absorbs or scatters at least a portion of the emitted light that reflects from or within the adhesive layer.
